(19) United States
(12) Patent Application Publication
(10) Pub. No.: US 2022/0358572 A1
(43) Pub. Date: Nov. 10, 2022

(54) DEVICE AND METHOD TO PROVIDE DATA ASSOCIATED WITH SHOPPING MALL WEB PAGE

(71) Applicant: NHN CLOUD CORPORATION, Gyeonggi-do (KR)

(72) Inventors: Hyeon-gi KIM, Gyeonggi-do (KR); Seonhee SEOK, Gyeonggi-do (KR); Sohee LEE, Gyeonggi-do (KR); Gun han PARK, Gyeonggi-do (KR)

(21) Appl. No.: 17/740,359

(22) Filed: May 10, 2022

(30) Foreign Application Priority Data
May 10, 2021 (KR) 10-2021-0060127

(51) Int. Cl. G06Q 30/06; G06V 10/774; G06F 16/58

(52) U.S. Cl. CPC G06Q 30/0643; G06V 10/7753; G06F 16/5866

(57) ABSTRACT

A method for providing data associated with a shopping mall web page includes accessing a review item written by a user ID in association with the shopping mall web page, the review item including an image and a text; detecting at least one target object from the image included in the review item; processing the detected target object to generate first feature data; processing a reference object included in the shopping mall web page to generate second feature data corresponding to the reference object; and outputting verification data indicating a result of verification for the review item by comparing the first feature data, generated by processing the target object, with the second feature data, generated by processing the reference object.

### CROSS REFERENCE TO RELATED APPLICATION

This application claims the priority to Korean Patent Application No. 10-2021-0039930, filed on Mar. 26, 2021, which is all hereby incorporated by reference in its entirety.

### BACKGROUND

### 1. Technical Field

The present disclosure generally relates to a shopping mall web page, and more particularly, to a device and method for providing data associated with a shopping mall web page.

### 2. Related Art

An artificial intelligence (AI) system may be a computer system that implements human-level intelligence. Unlike an existing rule-based smart system, the AI system can allow a machine to self-learn and make decisions so as to deduce a target result or perform a target operation. The more the AI system is used, the greater recognition rate is improved and the more accurately a user's preferences may be understood.

AI technology includes, for example, but not limited to, machine learning (e.g. deep learning) and element technologies using machine learning. The machine learning refers to an algorithm technology in which a machine classifies and learns characteristics of input data autonomously. The element technologies refer to technologies using a machine learning algorithm such as deep learning, and may be divided into fields of linguistic understanding, visual understanding, reasoning/prediction, knowledge representation, operation control, etc.

The AI technology is being actively researched in various fields. For example, element technologies for implementing AI technology may include at least one among linguistic understanding technology that recognizes verbal/written language of a human, visual understanding technology that recognizes objects as in human vision, reasoning/prediction technology that determines information and executes logical reasoning and prediction, knowledge representation technology that processes human experience information as knowledge data, and operation control technology that controls autonomous driving of a vehicle and motion of a robot.

The information described above is only provided for a better understanding of the background art of the technical features of the disclosure, and therefore it can not be understood as information which corresponds to the prior art known to those skilled in the art.

### SUMMARY

Various embodiments of the present disclosure are directed to a device and method which verifies data associated with a shopping mall web page with improved reliability and accuracy.

In an embodiment, a method for providing data associated with a shopping mall web page may include: accessing a review item written by a user ID in association with the shopping mall web page, the review item including an image and a text; detecting at least one target object from the image of the review item; processing the detected target object to generate first feature data; processing a reference object included in the shopping mall web page to generate second feature data corresponding to the reference object; and providing verification data indicating a result of verification for the review item by comparing the first feature data with the second feature data.

The generating of the first feature data may include processing the target object to generate at least one first feature vector associated with a design of the target object; the generating of the second feature data may include processing the reference object to generate at least one second feature vector associated with a design of the reference object; and the first feature data may include the first feature vector, and the second feature data may include the second feature vector.

In the providing of the verification data, according to whether the first feature vector matches the second feature vector, the verification data may indicate that the verification for the review item has been passed.

Each of the first feature vector and the second feature vector may be generated using an artificial intelligence model learned to output, when an image is inputted, at least one feature vector associated with a design of an object in the inputted image.

The generating of the first feature data may include processing the target object to generate first property tags associated with a property of a product corresponding to the target object; the generating of the second feature data may include processing the reference object to generate second property tags associated with a property of a product corresponding to the reference object; and the first feature data may include the first property tags, and the second feature data may include the second property tags.

In the providing of the verification data, according to whether the first property tags match the second property tags, the verification data may indicate that verification for the review item has been passed.

Each ones of the first property tags and the second property tags may be generated using an artificial intelligence model learned to output, when an image is inputted, property tags representing a property of a product corresponding to an object in the inputted image.

The method may further include: providing a reward to the user ID on the basis of the verification data.

In an embodiment, a computer device for providing data associated with a shopping mall web page may include: a first interface configured to access a review item written by a user ID in association with the shopping mall web page; and a processor configured to obtain the review item through the first interface, wherein the review item includes an image and a text, and wherein the processor is configured to detect at least one target object from the image of the review item, to process the detected target object to generate first feature data, to verify the review item by comparing the first feature data with second feature data corresponding to a reference object included in the shopping mall web page, and to provide verification data indicating a result of the verification.

The processor may be configured to process the target object to generate at least one first feature vector associated with a design of the target object, and process the reference object to generate at least one second feature vector associated with a design of the reference object; and the first feature data may include the first feature vector, and the second feature data may include the second feature vector.

The processor may provide, according to whether the first feature vector matches the second feature vector, the verification data to indicate that the verification for the review item has been passed.

The processor may be configured to generate each of the first feature vector and the second feature vector by using an artificial intelligence model learned to output, when an image is inputted, at least one feature vector associated with a design of an object in the inputted image.

The processor may be configured to process the target object to generate first property tags associated with a property of a product corresponding to the target object, and process the reference object to generate second property tags associated with a property of a product corresponding to the reference object; and the first feature data may include the first property tags, and the second feature data may include the second property tags.

The processor may provide, according to whether the first property tags match the second property tags, the verification data to indicate that the verification for the review item has been passed.

The processor may be configured to generate each ones of the first property tags and the second property tags by using an artificial intelligence model learned to output, when an image is inputted, property tags representing a property of a product corresponding to an object in the inputted image.

In an embodiment, there may be provided a computer device-readable storage medium suitable for storing a computer program, wherein the computer device is configured to access a review item written by a user ID in association with a shopping mall web page, wherein the review item includes an image and a text, and wherein, when being executed by the computer device, the computer program detects at least one target object from the image of the review item; processes the detected target object to generate first feature data; and verifies the review item by comparing the first feature data with second feature data corresponding to a reference object included in the shopping mall web page, and includes instructions for providing verification data indicating a result of verification.

According to the embodiments of the present disclosure, a device and method which verifies data associated with a shopping mall web page with improved reliability and accuracy is provided. For example, a computer device may verify a review item, written by a user in association with a shopping mall web page, by comparing a target object included in the review item with a reference object included in the shopping mall web page, and accordingly, the reliability and accuracy of verification for the review item may be improved, and faster verification times and smaller resource requirements for executing the verification for the review item (e.g.

memory and/or processor requirement) may be provided.

### BRIEF DESCRIPTION OF THE DRAWINGS

FIG. 1 is a block diagram illustrating a network system in accordance with an embodiment of the present disclosure.

FIG. 2 is a diagram illustrating an example of a web page provided by a shopping mall server of FIG. 1.

FIG. 3 is a diagram illustrating an example of a review item provided by a shopping mall server of FIG. 1.

FIG. 4 is a block diagram illustrating an embodiment of a shopping mall server of FIG. 1 in accordance with the present disclosure.

FIG. 5 is a block diagram illustrating an embodiment of a feature data generator of FIG. 4.

FIG. 6 is a block diagram illustrating another embodiment of a feature data generator of FIG. 4.

FIG. 7 is a conceptual diagram illustrating first feature data and second feature data of FIG. 4.

FIG. 8 is a flowchart illustrating a method of providing verification data associated with a shopping mall web page in accordance with an embodiment of the present disclosure.

FIG. 9 is a flowchart illustrating an embodiment of steps S130 to S150 of FIG. 8.

FIG. 10 is a flowchart illustrating another embodiment of steps S130 to S150 of FIG. 8.

FIG. 11 is a block diagram illustrating an embodiment of a computer device suitable for implementing a verification data providing device of FIG. 4.

FIG. 12 is a block diagram illustrating a client server capable of communicating with the computer device of FIG. 11.

### DETAILED DESCRIPTION

Hereinafter, embodiments of the disclosure will be described in detail with reference to the accompanying drawings. Hereafter, only parts necessary to understand the operation of the disclosure will be described, and it is to be noted that descriptions for the other parts will be omitted in order not to obscure the characterizing features of the disclosure. The disclosure may be embodied in different forms and should not be construed as being limited to the embodiment set forth herein. Rather, the embodiment is provided to describe the disclosure in detail to the extent that a person skilled in the art to which the disclosure pertains can easily carry out the technical ideas of the disclosure.

Throughout the specification, when one element is referred to as being ‘connected to’ or ‘coupled to’ another element, it may indicate that the former element is directly connected or coupled to the latter element or indirectly connected or coupled to the latter element with another element interposed therebetween. The terminology used herein is for the purpose of describing particular embodiments and is not intended to be limiting. In the entire specification, when an element “includes” a component, it means that the element does not exclude another component but may further include another component, unless referred to the contrary. “At least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

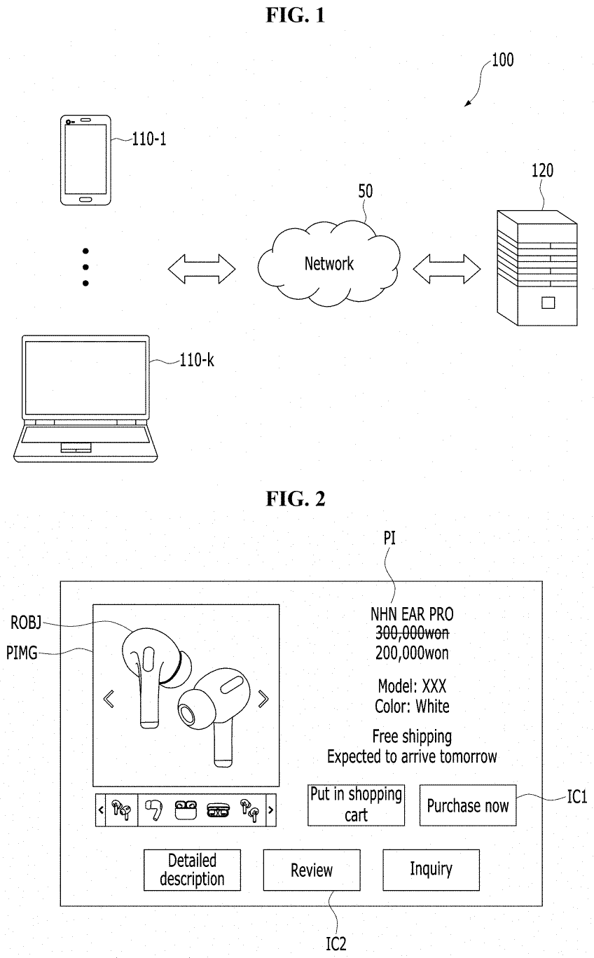

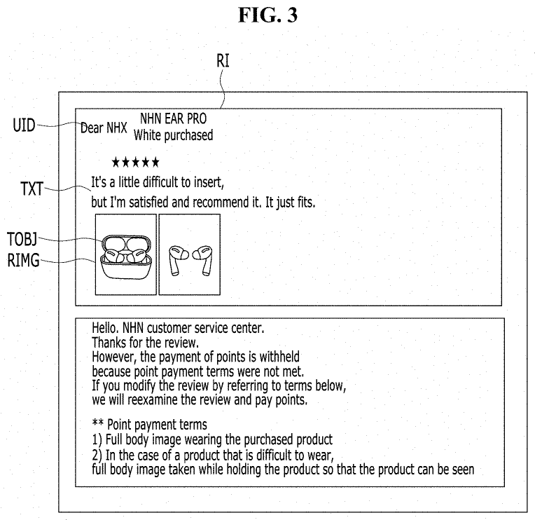

FIG. 1 is a block diagram illustrating a network system in accordance with an embodiment of the present disclosure. FIG. 2 is a diagram illustrating an example of a web page provided by a shopping mall server of FIG. 1. FIG. 3 is a diagram illustrating an example of a review item provided by a shopping mall server of FIG. 1.

Referring to FIG. 1, a network system 100 may include a network 50, first to k-th user terminals 110-1 to 110-k, and a shopping mall server 120.

The network system 100 may include a plurality of devices, servers and/or software components, which are configured to operate to perform various algorithms, instructions, and/or methods in accordance with some embodiments of the present disclosure described herein. The devices and/or servers illustrated in FIG. 1 may be configured in different ways. Operations and services provided by the devices and/or servers may be combined or separated for the embodiments described herein, and may be performed by a larger or smaller number of devices and/or servers. One or more devices and/or servers may be driven and/or maintained by the same entity (e.g. a company) or different entities (e.g. companies).

The network 50 connects components within the network system 100, such as the network 50, the first to k-th user terminals 110-1 to 110-k and the shopping mall server 120. The network 50 may include at least one among a public network, at least one private network, a wired network, a wireless network, other appropriate types of networks and combinations thereof. Each of the components in the network system 100 may have at least one of a wired communication function and a wireless communication function. Thus, the components in the network system 100 may communicate with one another through the network 50.

Each of the first to k-th user terminals 110-1 to 110-k may communicate with the shopping mall server 120 through the network 50. In certain embodiments, each of the first to k-th user terminals 110-1 to 110-k may include an application such as a web browser. For example, the application may perform various actions such as opening a user ID by accessing the shopping mall server 120, accessing a web page under the opened user ID, purchasing a product and writing a review for the product.

As an embodiment, each of the first to k-th user terminals 110-1 to 110-k may include a device capable of transmitting and/or receiving information in a wired and/or wireless environment, such as a computer, a UMPC (ultra mobile PC), a workstation, a net-book, a PDA (personal digital assistant), a portable computer, a web tablet, a wireless phone, a mobile phone, a smart phone, an e-book, a PMP (portable multimedia player) and a portable game machine.

The shopping mall server 120 may communicate with the first to k-th user terminals 110-1 to 110-k through the network 50, and may provide, in response to a request from one of the first to k-th user terminals 110-1 to 110-k, a web page to the corresponding user terminal. Referring to FIG. 2, a web page provided by the shopping mall server 120 may include an image PIMG of a product to be sold, information PI related to the product, a first icon IC1 for moving to a web page (or an interface) for purchase, and a second icon IC2 for moving to a web page (or a graphic interface) for writing a review on the product. Besides, the shopping mall server 120 may further include various icons, such as “Put in shopping cart,” “Detailed description” and “Inquiry,” according to necessity.

In response to a user input of selecting the second icon IC2, the user terminal may call the link associated with or included in the second icon IC2, to the shopping mall server 120. In response to the user terminal's calling of the link, the shopping mall server 120 may provide a web page (or a graphic interface) which can be used to write a review item, to the corresponding user terminal. FIG. 3 shows an example of a review item RI written by or associated with a user ID UID. The review item RI may include the user ID UID, at least a part of information PI (see FIG. 2) on a purchased product, a text TXT written by the user ID UID, and a review image RIMG. In FIG. 3, the review item RI includes the text TXT such as “It's a little difficult to insert, but I'm satisfied and recommend it. It just fits.,” and at least one review image RIMG of the purchased product.

The shopping mall server 120 may provide a reward (e.g., payment points) to the user ID UID who wrote the review item RI. To this end, it is verified whether the review item RI is proper as a review for the corresponding product or meet preset conditions, and the reward may be provided to the corresponding user ID UID according to a verification result. Although a human may directly verify the review item RI, various algorithms for verifying the review item RI have been proposed to improve economic efficiency. However, these algorithms may provide verification results of low reliability, and the verification results of low reliability may cause a reward to be unintentionally provided or not provided to the user ID UID, which may adversely affect a corresponding shopping mall service. For example, as shown in FIG. 3, in spite that the product is an earphone, it may be requested that the review image RIMG of the review item RI be a full body image for a verification pass, and a resultant inappropriate verification result may cause a reward not to be provided to the user ID UID, thereby adversely affecting the corresponding shopping mall service.

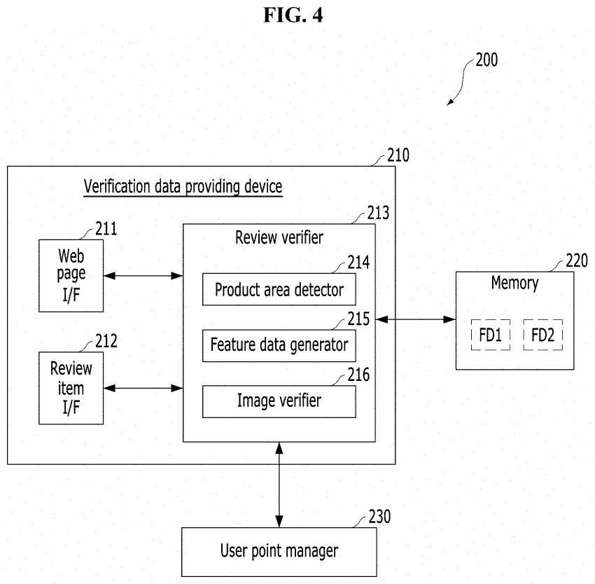

FIG. 4 is a block diagram illustrating an embodiment of the shopping mall server of FIG. 1 in accordance with the present disclosure.

Referring to FIG. 4, a shopping mall server 200 may include a verification data providing device 210, a memory 220 and a user point manager 230.

The verification data providing device 210 is connected to the user point manager 230. The verification data providing device 210 may use the memory 220 as a working memory. The verification data providing device 210 may include a web page interface (I/F) 211, a review item interface (I/F) 212 and a review verifier 213.

The web page interface 211 may provide an interface for a shopping mall web page to the review verifier 213. The review item interface 212 may provide an interface for a review item associated with the shopping mall web page to the review verifier 213. In this way, the review verifier 213 may access or receive data of the shopping mall web page through the web page interface 211, and may access or receive data of the review item through the review item interface 212.

The review verifier 213 is configured to verify review items associated with the shopping mall web page and provide a result of the verification for each review item to the user point manager 230. The review verifier 213 may include a product area detector 214, a feature data generator 215 and an image verifier 216.

The product area detector 214 is configured to access a review item through the review item interface 212 and detect or extract a target object TOBJ (see FIG. 3) from the review image RIMG (see FIG. 3) of the review item.

The feature data generator 215 is configured to process the detected target object TOBJ to generate first feature data FD1 representing the feature of the target object TOBJ such as a feature associated with the design of the target object TOBJ and/or a product property associated with the target object TOBJ. The first feature data FD1 may be temporarily stored in the memory 220.

The image verifier 216 is configured to verify the review item by comparing the first feature data FD1 with second feature data FD2 corresponding to a reference object ROBJ (see FIG. 2) of the shopping mall web page, and to generate verification data indicating a result of the verification. The verification data may indicate whether the verification of the corresponding review item has been passed, or whether the verification of the corresponding review item has failed.

In some embodiments, the product area detector 214 and the feature data generator 215 may perform the same operations as the above-described operations of processing the review image RIMG, for the product image PIMG (see FIG. 2). The product area detector 214 may obtain the product image PIMG of the shopping mall web page through the web page interface 211, and may detect or extract the reference object ROBJ (see FIG. 2) from the product image PIMG. In addition, the feature data generator 215 is configured to process the reference object ROBJ to generate the second feature data FD2 representing the feature of the reference object ROBJ such as a feature associated with the design of the reference object ROBJ and/or a product property associated with the reference object ROBJ. The second feature data FD2 may be temporarily stored in the memory 220, and the image verifier 216 may verify whether the first feature data FD1 stored in the memory 220 matches the second feature data FD2, to generate verification data.

As such, the review verifier 213 may verify each review item by comparing the first feature data FD1 according to the target object TOBJ with the second feature data FD2 according to the reference object ROBJ. When considering that the first feature data FD1 and the second feature data FD2 reflect the visual features of the target object TOBJ and the reference object ROBJ, respectively, verification according to the comparison of the first feature data FD1 and the second feature data FD2 may be adaptively performed for a product, and accordingly, a result of the verification may have high reliability and accuracy, and faster verification times and smaller resource requirements for executing the verification for the review item (e.g. memory and/or processor requirement) may be provided.

The user point manager 230 may provide a reward to the user ID UID (see FIG. 3) on the basis of the verification data from the image verifier 216. In certain embodiments, the user point manager 230 is configured to manage points corresponding to each user ID, and may increase or decrease points corresponding to the user ID UID according to the verification data.

Although not shown in FIG. 2, the shopping mall server 120 may further include a web page provider for providing and managing a shopping mall web page as exemplified in FIG. 2, review items and data associated with them.

In some embodiments, the verification data providing device 210 and the memory 220 may be provided as components of the shopping mall server 120 of FIG. 1. In alternative embodiments, the verification data providing device 210 and the memory 220 may be provided as components separated from the shopping mall server 120 of FIG. 1. In these embodiments, the verification data providing device 210 may access the shopping mall server 120, for example, web pages and review items provided by the shopping mall server 120, through the network 50.

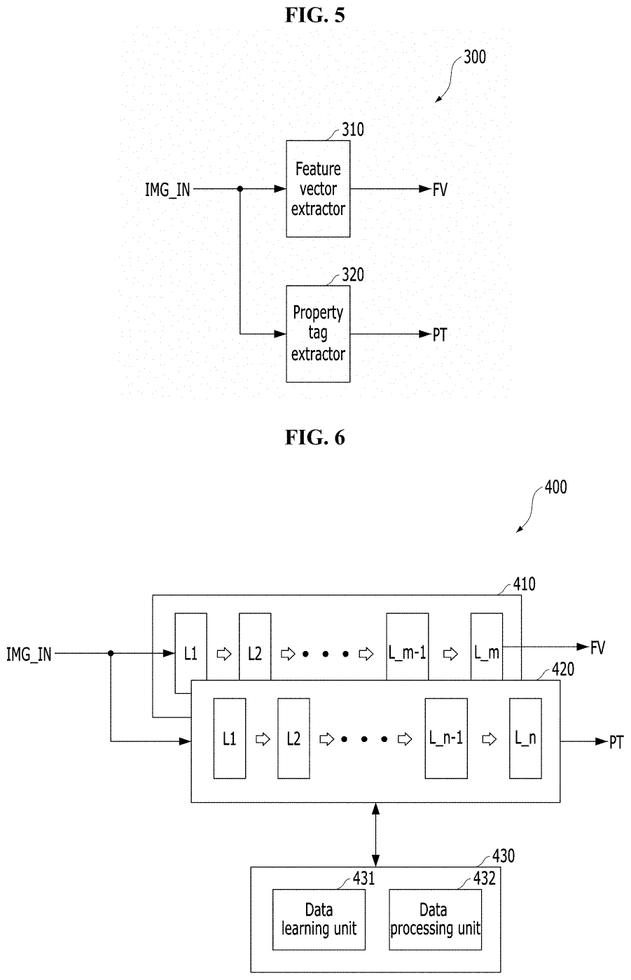

FIG. 5 is a block diagram illustrating an embodiment of the feature data generator of FIG. 4.

Referring to FIG. 5, a feature data generator 300 (for example, the feature data generator 215 of FIG. 4) may include a feature vector extractor 310 and a property tag extractor 320. Each of the feature vector extractor 310 and the property tag extractor 320 may perform image processing to generate data associated with a corresponding object or image.

The feature vector extractor 310 is configured to process an inputted image (or object) IMG_IN to generate at least one feature vector FV associated with the design of the object of the input image IMG_IN. In certain embodiments, the feature vector extractor 310 may generate a feature vector representing the color of at least a part of the object and a feature vector representing feature points of the object. The input image IMG_IN may be the target object TOBJ (see FIG. 3) or the review image RIMG (see FIG. 3). Also, the input image IMG_IN may be the reference object ROBJ (see FIG. 2) or the product image PIMG (see FIG. 2).

The property tag extractor 320 is configured to process the input image (or object) IMG_IN to generate at least one property tag PT representing a product property corresponding to the object of the input image IMG_IN. In some embodiments, the property tag extractor 320 may generate various property tags such as a property tag representing a type (or category) (e.g., pants) of a product corresponding to an object, a property tag representing a representative color (e.g., blue) of a product corresponding to an object, a property tag representing material (e.g., cotton) of a product corresponding to an object and a property tag representing a length of a sleeve (e.g., shorts) of a product corresponding to an object.

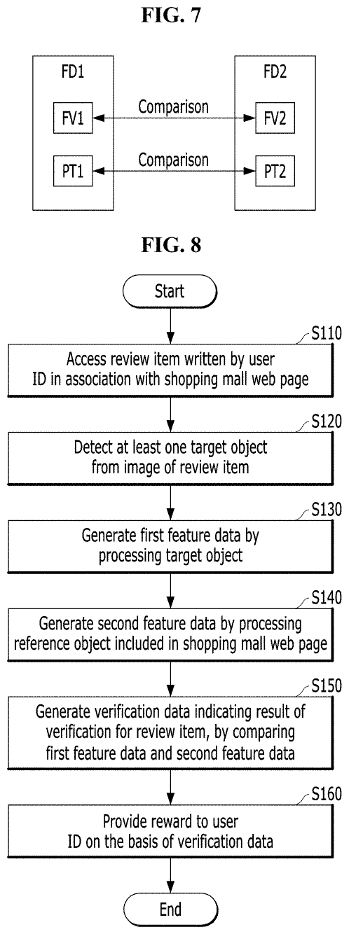

FIG. 6 is a block diagram illustrating another embodiment of the feature data generator of FIG. 4. FIG. 7 is a conceptual diagram illustrating first feature data and second feature data of FIG. 4.

Referring to FIG. 6, a feature data generator 400 (for example, the feature data generator 215 of FIG. 4) may include a first artificial intelligence model 410, a second artificial intelligence model 420 and an artificial intelligence processor 430.

The first artificial intelligence model 410 may be provided as the feature vector extractor 310 of FIG. 5. The first artificial intelligence model 410 may learn in advance to output the feature vector FV when an input image IMG_IN is inputted. In the embodiment illustrated in FIG. 6, the first artificial intelligence model 410 may include one or more neural networks L1, L2, . . . , L_(m-1), and L_m. The neural networks L1, L2, . . . , L_(m-1), and L_m may learn to output the feature vector FV when the image IMG_IN is inputted. For example, the neural networks L1, L2, . . . , L_(m-1), and L_m may include neural networks corresponding to an encoder for extracting a feature from the image IMG_IN in a learned manner, and neural networks corresponding to a decoder for converting the extracted feature into the feature vector FV.

The second artificial intelligence model 420 may be provided as the property tag extractor 320 of FIG. 5. The second artificial intelligence model 420 may learn in advance to output the property tag PT when the input image IMG_IN is inputted. In the embodiment illustrated in FIG. 6, the second artificial intelligence model 420 may include one or more neural networks L1, L2, . . . , L_(n-1) and L n. The neural networks L1, L2, . . . , L_(n-1) and L n may learn to output the property tag PT when the image IMG_IN is inputted. For example, the neural networks L1, L2, . . . , L_(n-1) and L n may include neural networks corresponding to an encoder for extracting a feature from the image IMG_IN in a learned manner, and neural networks corresponding to a decoder for converting the extracted feature into the property tag PT.

The artificial intelligence processor 430 is configured to control the first and second artificial intelligence models 410 and 420. The artificial intelligence processor 430 may include a data learning unit 431 and a data processing unit 432. The data learning unit 431 may cause, by using learning data including an image and a feature vector corresponding thereto, the first artificial intelligence model 410 to learn so that the feature vector FV is outputted when the image IMG_IN is inputted to the first artificial intelligence model 410. Moreover, the data learning unit 431 may cause, by using learning data including an image and a property tag corresponding thereto, the second artificial intelligence model 420 to learn so that the property tag PT is outputted when the image IMG_IN is inputted to the second artificial intelligence model 420. Data for such learning may be obtained from an arbitrary database server through the network 50 (see FIG. 1).

The data processing unit 432 may generate a first feature vector FV1 of FIG. 7 as a result value by inputting the target object TOBJ or the review image RIMG of FIG. 3 as the image IMG_IN to the learned first artificial intelligence model 410, and may generate a first property tag PT1 of FIG. 7 as a result value by inputting the target object TOBJ or the review image RIMG as the image IMG_IN to the learned second artificial intelligence model 420. The first feature vector FV1 and the first property tag PT1 may be included in the first feature data FD1 of FIG. 4 as shown in FIG. 7. Also, the data processing unit 432 may generate a second feature vector FV2 of FIG. 7 as a result value by inputting the reference object ROBJ or the product image PIMG of FIG. as the image IMG_IN to the learned first artificial intelligence model 410, and may generate a second property tag PT2 of FIG. 7 as a result value by inputting the reference object ROBJ or the product image PIMG as the image IMG_IN to the learned second artificial intelligence model 420. The second feature vector FV2 and the second property tag PT2 may be included in the second feature data FD2 of FIG. 4 as shown in FIG. 7.

The image verifier 216 of FIG. 4 may verify the review item RI (see FIG. 3) by determining whether the first feature vector FV1 matches the second feature vector FV2 and/or whether the first property tag PT1 matches the second property tag PT2. In certain embodiments, whether the first feature vector FV1 matches the second feature vector FV2 and whether the first property tag PT1 matches the second property tag PT2 may be determined according to whether the difference between two values is within the range of a preset threshold.

In some embodiments, the first artificial intelligence model 410, the second artificial intelligence model 420 and the artificial intelligence processor 430 may be implemented by one or more processors and one or more memories. The processor may include one or more cores such as a single core, a dual core and a quad core. The processor may provide the first artificial intelligence model 410, the second artificial intelligence model 420 and the artificial intelligence processor 430 by loading a program and/or instructions on the memory and executing the loaded program and/or instructions.

FIG. 8 is a flowchart illustrating a method of providing verification data associated with a shopping mall web page in accordance with an embodiment of the present disclosure.

Referring to FIG. 8, at step S110, a review item (e.g. RI of FIG. 3) written by or associated with a user ID in association with a shopping mall web page is accessed. At step S120, at least one target object (e.g. TOBJ of FIG. 3) is detected from the image of the review item accessed at step S110.

At step S130, first feature data is generated by processing the target object. At step S140, second feature data is generated by processing a reference object (e.g. ROBJ of FIG. 2) of an image (e.g. PIMG of FIG. 2) included in the shopping mall web page.

At step S150, verification of the review item is performed, and verification data indicating a result of the verification is generated.

For example, the verification of the review item is performed by comparing the first feature data and the second feature data with each other. In this way, by comparing the first feature data according to the target object with the second feature data according to the reference object, the review item may be verified. When considering that the first feature data and the second feature data reflect the visual features of the target object and the reference object, respectively, the verification according to the comparison of the first feature data and the second feature data may be adaptively performed for a product, and accordingly, the verification data may have high reliability and accuracy, and faster verification times and smaller resource requirements for executing the verification for the review item (e.g. memory and/or processor requirement) may be provided.

At step S160, a reward is provided to the user ID having written the review item, on the basis of the verification data generated at step S150. For example, points corresponding to the user ID may be increased or decreased according to the verification data.

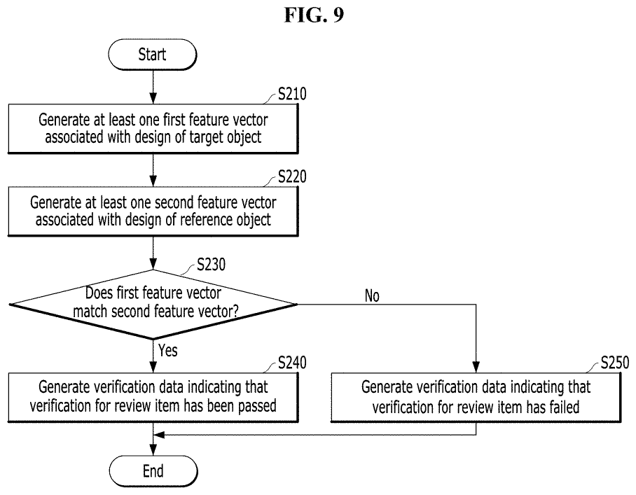

FIG. 9 is a flowchart illustrating an embodiment of steps S130 to S150 of FIG. 8.

Referring to FIG. 9, at step S210, at least one first feature vector associated with the design of the target object is generated. The step S210 may be performed as step S130 of FIG. 8. At step S220, at least one second feature vector associated with the design of the reference object is generated. The step S220 may be performed as step S140 of FIG. 8.

Steps S210 and S220 may be performed using an artificial intelligence model (e.g. the first artificial intelligence model 410 of FIG. 6) learned to output, when an image or an object is inputted, a corresponding feature vector (e.g., a feature vector representing at least a partial color of the object and/or a feature vector representing feature points of the object).

Steps S230 to S250 may be performed as step S150 of FIG. 8. At step S230, it is determined whether the first feature vector matches the second feature vector. If the first feature vector matches the second feature vector, step S240 is performed. If the first feature vector does not match the second feature vector, step S250 is performed.

At step S240, verification data indicating that verification for the review item has been passed is generated.

At step S250, verification data indicating that verification for the review item has failed (or the review item is not associated with the corresponding product) is generated.

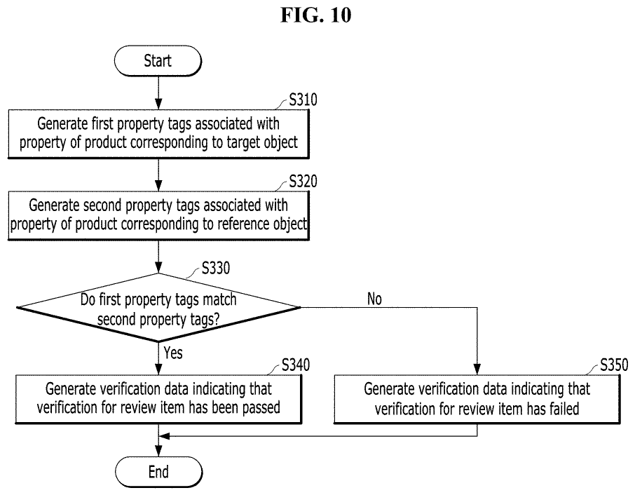

FIG. 10 is a flowchart illustrating another embodiment of steps S130 to S150 of FIG. 8.

Referring to FIG. 10, at step S310, first property tags associated with the property of the product corresponding to the target object are generated. Step 5310 may be performed as step S130 of FIG. 8. At step S320, second property tags associated with the property of the product corresponding to the reference object are generated. Step 5320 may be performed as step S140 of FIG. 8.

Steps S310 and S320 may be performed using an artificial intelligence model (for example, the second artificial intelligence model 420 of FIG. 6) learned to output corresponding property tags when the image or the object is inputted. For example, the artificial intelligence model may have learned to output a property tag representing a type (or category) of a product corresponding to an object, a property tag representing a representative color of the product corresponding to the object, a property tag representing material of a product corresponding to an object and a property tag representing a length of a sleeve of a product corresponding to an object.

Steps S330 to S350 may be performed as step S150 of FIG. 8. At step S330, it is determined whether the first property tags match the second property tags, respectively. If the first property tags match the second property tags, the step S340 is performed. If the first property tags do not match the second property tags, the step S350 is performed. Steps S340 and S350 are performed in the same or similar manner as or to steps S240 and S250 of FIG. 9, respectively.

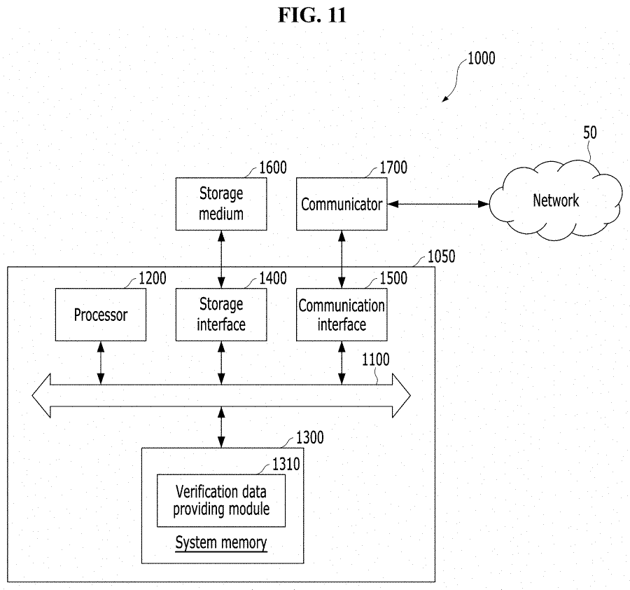

FIG. 11 is a block diagram illustrating an embodiment of a computer device suitable for implementing the verification data providing device of FIG. 4.

Referring to FIG. 11, a computer device 1000 may include a bus 1100, at least one processor 1200, a system memory 1300, a storage interface (I/F) 1400, a communication interface 1500, a storage medium 1600, and a communicator 1700.

The bus 1100 is connected to various elements of the computer device 1000 to transfer data, a signal, and information. The processor 1200 may be any one of a general-purpose processor and a dedicated processor, and may control overall operations of the computer device 1000.

The processor 1200 is configured to load, in the system memory 1300, program codes and instructions that provide various functions when being executed, and to process the loaded program codes and instructions. The system memory 1300 may be provided as a working memory of the processor 1200. For instance, the system memory 1300 may include at least one among a random access memory (RAM), a read only memory (ROM) and other types of computer-readable media.

The processor 1200 may load a verification data providing module 1310, which provides the functions of the verification data providing device 210 of FIG. 4 when being executed by the processor 1200, in the system memory 1300. The program codes and/or instructions may be executed by the processor 1200 to perform the functions and/or operations of the verification data providing device 210 described above with reference to FIG. 4. In order to perform such functions and/or operations, the verification data providing module 1310 executed by the processor 1200 may use the components of the computer device 1000 such as the storage interface 1400 and the communication interface 1500. For example, in the verification data providing module 1310, modules performing the functions of the web page interface 211 and the review item interface 212 of FIG. 4 may communicate with components on the network 50 of FIG. 1 through the communication interface 1500 and the communicator 1700.

The program codes and/or instructions may be loaded in the system memory 1300 from the storage medium 1600 as a separate computer-readable recording medium. Alternatively, the program codes and/or instructions may be loaded from the outside of the computer device 1000 to the system memory 1300 through the communicator 1700. In addition, the system memory 1300 may function as a buffer memory for the verification data providing module 1310. For example, the system memory 1300 may be provided as the memory 220 of FIG. 4.

In FIG. 11, the system memory 1300 is illustrated as a component separated from the processor 1200, but at least a part of the system memory 1300 may be included in the processor 1200. According to some embodiments, the system memory 1300 may be provided or implemented as a plurality of memories which are physically and/or logically separated from each other.

The storage interface 1400 is connected to the storage medium 1600. The storage interface 1400 may be configured to interface between components, such as the processor 1200 and the system memory 1300 connected to the bus 1100, and the storage medium 1600. The communication interface 1500 is connected to the communicator 1700. The communication interface 1500 may be configured to interface between components, connected to the bus 1100, and the communicator 1700.

In certain embodiments, the bus 1100, the processor 1200 and the system memory 1300 may be integrated into one board 1050. For example, the bus 1100, the processor 1200 and the system memory 1300 may be mounted on one semiconductor chip. In some embodiments, the board 1050 may further include the storage interface 1400 and the communication interface 1500.

Examples of the storage medium 1600 may include various types of nonvolatile storage media, for example, a flash memory and a hard disk, which retain data stored therein even when power is cut off.

The communicator (or a transceiver) 1700 may transmit and receive signals between the computer device 1000 and other devices and/or servers within the network system 100 (see FIG. 1) through the network 50.

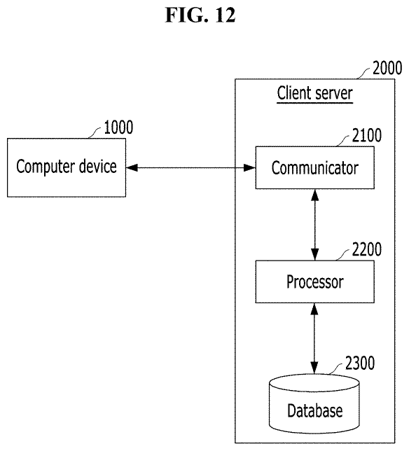

FIG. 12 is a block diagram illustrating a client server capable of communicating with the computer device of FIG. 11.

Referring to FIG. 12, a client server 2000 may be connected to the computer device 1000 of FIG. 11 through the network 50 (see FIG. 1). A computer program, such as an application, to be executed by the computer device 1000 may be provided from the client server 2000. Referring to FIG. 12, the client server 2000 may include a communicator 2100, a processor 2200 and a database 2300. The communicator 2100 may communicate with the computer device 1000 through the network 50. The database 2300 may store a computer program executable by the computer device 1000 and/or the processor 1200 of FIG. 11, for example, the verification data providing module 1310 of FIG. 11 or an installation file thereof. The database 2300 may be implemented by at least one of nonvolatile storage media such as a flash memory, a hard disk and a multimedia card.

The processor 2200 may provide the computer program stored in the database 2300 to the computer device 1000 through the communicator 2100 in response to a request from the computer device 1000. The computer program may be installed and executed in the computer device 1000.

Although particular embodiments and application examples are described, they are provided only for assisting in the entire understanding of the disclosure. Therefore, the disclosure is not limited to the exemplary embodiments, and various modifications and changes may be made by those skilled in the art to which the disclosure pertains, from this description.

Therefore, the spirit of the disclosure should not be limited to the above-described exemplary embodiments, and the following claims as well as all modified equally or equivalently to the claims are intended to fall within the scopes and spirit of the disclosure.

What is claimed is:

1. A method for providing data associated with a shopping mall web page, the method comprising:
accessing a review item associated with a user ID in the shopping mall web page, the review item including an image and a text;
detecting at least one target object from the image included in the review item;
processing the detected target object to generate first feature data;
processing a reference object included in the shopping mall web page to generate second feature data corresponding to the reference object; and
generating verification data indicating a result of verification for the review item by comparing the first feature data, generated by processing the target object, with the second feature data, generated by processing the reference object.

2. The method according to claim 1, wherein:
the processing of the detected target object to generate the first feature data comprises processing the target object to generate at least one first feature vector associated with a design of the target object,
the processing of the reference object included in the shopping mall web page to generate the second feature data comprises processing the reference object to generate at least one second feature vector associated with a design of the reference object, and
the first feature data comprises the first feature vector, and the second feature data comprises the second feature vector.

3. The method according to claim 2, wherein the generating of the verification data indicating the result of verification for the review item comprises, in response to determination that the first feature vector matches the second feature vector, generating the verification data indicating that the verification for the review item has been passed.

4. The method according to claim 2, wherein the first feature vector and the second feature vector are generated using an artificial intelligence model learned to, in response to an input of an image inputted to the artificial intelligence model, output at least one feature vector associated with a design of an object in the image inputted to the artificial intelligence model.

5. The method according to claim 1, wherein
the processing of the detected target object to generate the first feature data comprises processing the target object to generate first property tags associated with a property of a product corresponding to the target object,
the processing of the reference object included in the shopping mall web page to generate the second feature data comprises processing the reference object to generate second property tags associated with a property of a product corresponding to the reference object, and
the first feature data comprises the first property tags, and the second feature data comprises the second property tags.

6. The method according to claim 5, wherein the generating of the verification data indicating the result of verification for the review item comprises, in response to determination that the first property tags match the second property tags, generating the verification data indicating that verification for the review item has been passed.

7. The method according to claim 5, wherein the first property tags and the second property tags are generated using an artificial intelligence model learned to, in response to an input of an image inputted to the artificial intelligence model, output property tags representing a property of a product corresponding to an object in the image inputted to the artificial intelligence model.

8. The method according to claim 1, further comprising:
providing a reward to the user ID based on the verification data.

9. A computer device for providing data associated with a shopping mall web page, the computer device comprising:
a first interface configured to access a review item associated with a user ID in the shopping mall web page; and
a processor configured to receive the review item through the first interface,
wherein the review item includes an image and a text, and
wherein the processor is configured to detect at least one target object from the image included in the review item, to process the detected target object to generate first feature data, to verify the review item by comparing the first feature data, generated by processing the target object, with second feature data corresponding to a reference object included in the shopping mall web page, and to generate verification data indicating a result of verification for the review item.

10. The computer device according to claim 9, wherein
the processor is configured to process the target object to generate at least one first feature vector associated with a design of the target object, and process the reference object to generate at least one second feature vector associated with a design of the reference object, and
the first feature data comprises the first feature vector, and the second feature data comprises the second feature vector.

11. The computer device according to claim 10, wherein the processor is configured to, in response to determination that the first feature vector matches the second feature vector, generate the verification data to indicate that the verification for the review item has been passed.

12. The computer device according to claim 10, wherein the processor is configured to generate the first feature vector and the second feature vector by using an artificial intelligence model learned to, in response to an input of an image inputted to the artificial intelligence model, output at least one feature vector associated with a design of an object in the image inputted to the artificial intelligence model.

13. The computer device according to claim 9, wherein:
the processor is configured to process the target object to generate first property tags associated with a property of a product corresponding to the target object, and process the reference object to generate second property tags associated with a property of a product corresponding to the reference object, and
the first feature data comprises the first property tags, and the second feature data comprises the second property tags.

14. The computer device according to claim 13, wherein the processor is configured to, in response to determination that the first property tags match the second property tags, generate the verification data to indicate that the verification for the review item has been passed.

15. The computer device according to claim 13, wherein the processor is configured to generate the first property tags and the second property tags by using an artificial intelligence model learned to, in response to an input of an image inputted to the artificial intelligence model, output property tags representing a property of a product corresponding to an object in the image inputted to the artificial intelligence model.

16. A computer device-readable storage medium suitable for storing a computer program,
wherein the computer device is configured to access a review item associated with a user ID in a shopping mall web page,
wherein the review item includes an image and a text, and
wherein the computer program comprises commands, when being executed by the computer device, to:
detect at least one target object from the image included in the review item;
process the detected target object to generate first feature data; and
verify the review item by comparing the first feature data, generated by processing the target object, with second feature data corresponding to a reference object included in the shopping mall web page to provide verification data indicating a result of verification for the review item.
